(19) United States
(12) Patent Application Publication
(10) Pub. No.: US 2020/0211256 A1
(43) Pub. Date: Jul. 2, 2020

(54) APPARATUS AND METHOD FOR GENERATING 3D GEOGRAPHIC DATA

(71) Applicant: Electronics and Telecommunications Research Institute, Daejeon (KR)

(72) Inventors: Hye-Sun KIM, Daejeon (KR); Kyung-Kyu KANG, Daejeon (KR); Chang-Joon PARK, Daejeon (KR); Yun-Ji BAN, Daejeon (KR); Dong-Wan RYOO, Daejeon (KR); Jung-Jae YU, Daejeon (KR); Man-Hee LEE, Daejeon (KR); Chang-Woo CHU, Daejeon (KR)

(73) Assignee: Electronics and Telecommunications Research Institute, Daejeon (KR)

(21) Appl. No.: 16/664,427

(22) Filed: Oct. 25, 2019

(30) Foreign Application Priority Data
Dec. 31, 2018 (KR) 10-2018-0173362
May 29, 2019 (KR) 10-2019-0063080

(51) Int. Cl. G06T 15/04; G06T 17/20; G06T 17/05; G06T 19/20; G06T 17/10

(52) U.S. Cl. CPC G06T 15/04; G06T 17/20; G06T 2200/08; G06T 19/20; G06T 17/10; G06T 17/05

(57) ABSTRACT

Disclosed herein is an operating method of an apparatus for generating 3D geographic data. The operating method may include receiving multi-view images, generating a 3D mesh and texture for a first distance view from the multi-view images, generating hybrid Digital Surface Model (DSM) data for a second distance view using the 3D mesh and the texture, and generating DSM data for a third distance view using the 3D mesh and the texture.

### CROSS REFERENCE TO RELATED APPLICATIONS

This application claims the benefit of Korean Patent Application No. 10-2018-0173362, filed Dec. 31, 2018, and No. 10-2019-0063080, filed May 29, 2019, which are hereby incorporated by reference in their entireties into this application.

### BACKGROUND OF THE INVENTION

### 1. Technical Field

The present invention relates to an apparatus and method for generating three-dimensional (3D) geographic data.

### 2. Description of the Related Art

Generally, the scale of an aerial photograph is defined as the ratio between the focal length of a camera and the altitude of a plane above the ground. However, the focal length of a camera varies at almost every point on the photograph due to differences in slopes and heights, and thus all points thereon may actually have different scales. That is, because an aerial photograph does not have a fixed scale over the entire area thereof, unless a process of removing relief displacement is performed, the aerial photograph cannot be used to measure a distance or angle relative to a specific aboveground object or to accurately extract the position thereof. Here, an aerial photograph from which displacement is removed such that all points thereon have a uniform scale as in a general map is referred to as an ‘orthophoto’. Meanwhile, conventional methods for generating large-scale geographic data have a disadvantage in that a lot of manual work is required in order to generate data about aboveground objects. Here, the aboveground objects are manually generated and arranged one by one, and multiple levels of simplified meshes must be generated depending on the level of detail (LOD). Accordingly, it takes a lot of time and expense to generate large-scale geographic data.

### DOCUMENTS OF RELATED ART

(Patent Document 1) Korean Patent No. 10-1766154, published on Aug. 1, 2017 and titled “Method and system for automatically generating orthophoto texture using DEM data”
(Patent Document 2) Korean Patent No. 10-1668006, published on Oct. 14, 2016 and titled “Method and system for constructing 3D spatial data based on satellite”
(Patent Document 3) Korean Patent No. 10-1548647, published on Aug. 25, 2015 and titled “Processor for visualization of 3D geographic data and operating method thereof”.

### SUMMARY OF THE INVENTION

An object of the present invention is to provide an apparatus and method for generating 3D geographic data, which may reduce the time and expense taken to generate geographic data.

The technical objects of the present invention are not limited to the above technical object, and other technical objects that are not mentioned will be readily understood by a person of ordinary skill in the art from the following description.

An operating method of an apparatus for generating 3D geographic data according to an embodiment of the present invention may include receiving multi-view images; generating a 3D mesh and texture for a first distance view from the multi-view images; generating hybrid Digital Surface Model (DSM) data for a second distance view using the 3D mesh and the texture; and generating DSM data for a third distance view using the 3D mesh and the texture.

In an embodiment, receiving the multi-view images may include receiving the multi-view images for target geography from at least one of a drone, an airplane, and a satellite.

In an embodiment, generating the 3D mesh and the texture may include calculating 3D information from the multi-view images, thereby generating the 3D mesh and texture that are capable of being visualized in a 3D program.

In an embodiment, the operating method may further include storing the 3D mesh and the texture for the first distance view in a first distance view layer.

In an embodiment, storing the 3D mesh and the texture may include simplifying a mesh/texture with an increase in a viewpoint distance; classifying the simplified mesh/texture for each detailed geographic layer; and storing the mesh/texture for each detailed geographic layer in the first distance view layer.

In an embodiment, generating the hybrid DSM data may include reprocessing the 3D mesh and the texture in the form of a height map, thereby generating the hybrid DSM data.

In an embodiment, the operating method may further include storing the hybrid DSM data in a second distance view layer.

In an embodiment, generating the hybrid DSM data may further include generating a hybrid ortho-texture map for displaying information about lateral surfaces of aboveground objects.

In an embodiment, generating the hybrid DSM data may further include interpolating a direction in which a DSM texture is remapped from a 3D mesh depending on the direction of a clipping plane of each grid cell.

In an embodiment, the operating method may further include storing the DSM data in a third distance view layer.

In an embodiment, storing the DSM data may include storing a true ortho-texture along with the DSM data.

An apparatus for generating 3D geographic data according to an embodiment of the present invention may include at least one processor; and memory for storing at least one instruction executed by the at least one processor. The at least one instruction may be executed by the at least one processor so as to receive multi-view images, to generate a 3D mesh and texture for a first distance view from the multi-view images, to generate a hybrid Digital Surface Model (DSM) dataset for a second distance view using the 3D mesh and the texture, and to generate a DSM dataset for a third distance view using the 3D mesh and the texture.

In an embodiment, the hybrid DSM dataset may include hybrid DSM data in the form of a height map and texture UV values having information about lateral surfaces of aboveground objects.

In an embodiment, a DSM texture may be remapped from the 3D mesh by performing interpolation depending on the direction of a clipping plane of each grid cell.

In an embodiment, the hybrid DSM dataset may include hybrid DSM data in the form of a height map and a hybrid ortho-texture having information about lateral surfaces of aboveground objects.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are exemplary views that show general Digital Elevation Model (DEM) data;

FIGS. 2A and 2B are views that show general conversion using a true ortho-texture map;

FIGS. 3A and 3B are views that show the general addition of aboveground object meshes;

FIGS. 4A and 4B are views that show a general geographic data structure;

FIGS. 5A, 5B and 5C are exemplary views that show a method for storing geographic data depending on a viewpoint distance according to an embodiment of the present invention;

FIG. 6 is an exemplary view that shows an apparatus for generating 3D geographic data according to an embodiment of the present invention;

FIGS. 7A and 7B are exemplary views that show a multi-view image and the estimated position and orientation of a camera;

FIGS. 8A and 8B are exemplary views that show partitioning and generation of a mesh and texture for large-scale geography;

FIGS. 9A and 9B are views for comparing the data size of a 3D mesh with that of DSM data;

FIGS. 10A, 10B, 10C and 10D are exemplary views that show a combination of DSM data and true ortho-texture;

FIGS. 11A, 11B, 11C, 11D and 11E are exemplary views that show a combination of a hybrid DSM and hybrid ortho-texture;

FIG. 12 is an exemplary view that shows an operating method of an apparatus for generating 3D geographic data according to an embodiment of the present invention; and

FIG. 13 is an exemplary view that shows an apparatus for generating 3D geographic data according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms. These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, terms used herein are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings in the related art, and are not to be interpreted as having ideal or excessively formal meanings unless they are definitively defined in the present specification.

An apparatus and method for generating 3D geographic data according to an embodiment of the present invention may be configured to store 3D geographic data as a hierarchical dataset that includes a 3D mesh/texture for a short-distance view, hybrid Digital Surface Model (DSM) data for a middle-distance view, and DSM data for a long-distance view depending on the visualization viewpoint of large-scale geography. Here, the geographic dataset for a middle-distance view is represented along with information about the texture of lateral surfaces of buildings or terrain, and a hybrid DSM and a hybrid ortho-texture set, which have high visualization efficiency, may be generated.

Generally, in order to generate large-scale geographic data, a Digital Elevation Model (DEM), true ortho-texture, and a method for generating an object mesh model are mainly used.

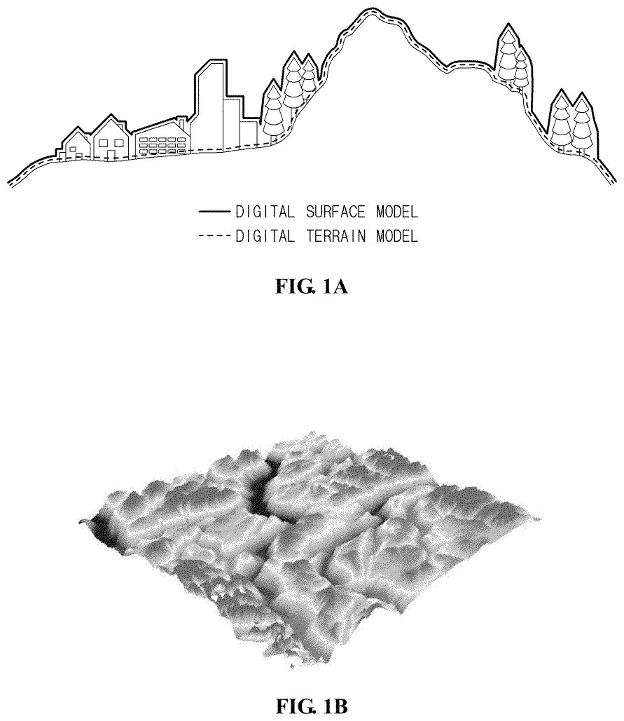

FIGS. 1A and 1B are views that show general DEM data. Referring to FIG. 1A, a Digital Surface Model (DSM) and a Digital Terrain Model (DTM) are illustrated. Here, DEM data stores only the height of terrain, excluding heights of aboveground objects, such as buildings, vegetation, and the like. DTM data is vector data configured with regularly spaced points and natural features such as ridges and breaklines. Here, the DTM data includes linear features of bare-earth terrain. Generally, terrain elevation data in the form of a height map, which stores only elevations at regularly spaced points, is stored for the convenience of transmission and visualization, as shown in FIG. 1B.

Meanwhile, in order to add color information to DEM data, it is necessary to map texture information. To this end, a suitable true ortho-texture map is applied to DEM data, which include only vertical height information and do not include information about lateral surfaces. In order to generate a true orthoimage, a precise DSM, which provides not only dense ground information but also information about the surfaces of all objects such as the heights of buildings or vegetation, is required.

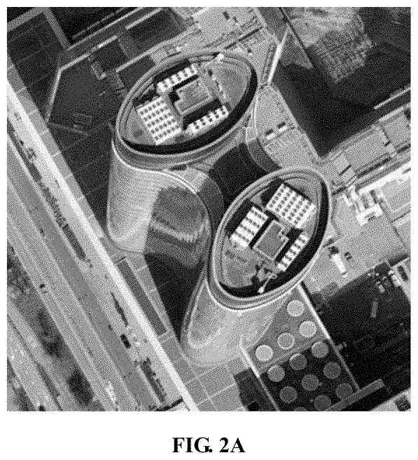

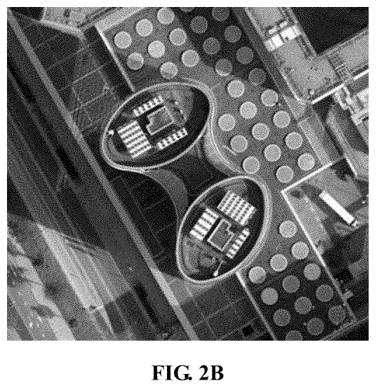

FIGS. 2A and 2B are views that show general conversion using a true ortho-texture map. The general perspective image shown in FIG. 2A may be converted into the orthoimage shown in FIG. 2B.

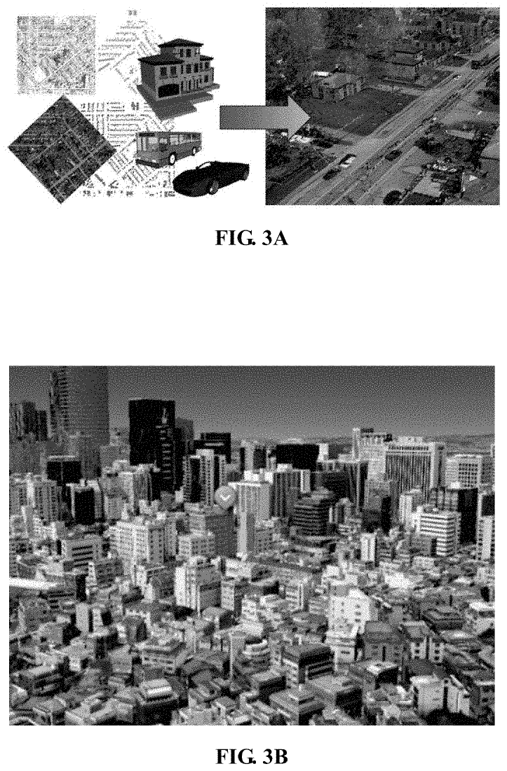

FIG. 3A is a view that shows an orthoimage to which aboveground object meshes are applied, and FIG. 3B is a view that shows the result of 3D visualization after the aboveground object meshes are applied. When only terrain elevations and an orthoimage are used, it is difficult to represent aboveground objects, such as buildings, structures, vegetation, and the like. Existing apparatuses for generating 3D geographic data separately store data about aboveground objects in the form of a 3D mesh for an overlay, as shown in FIGS. 3A and 3B.

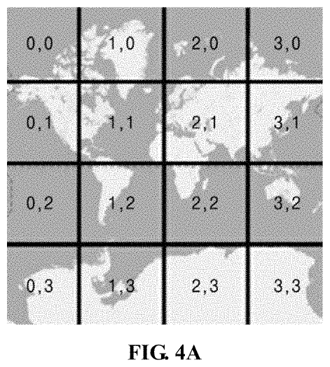

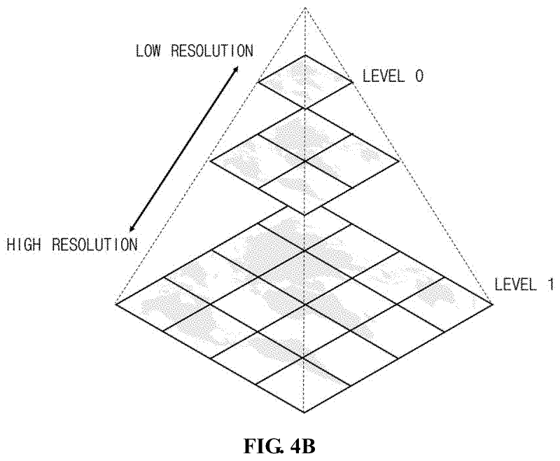

FIGS. 4A and 4B are exemplary views that show a general geographic data structure. As shown in FIG. 4A, geographic data, which includes a DEM, true ortho-texture, and an aboveground object set, takes a grid form, which consists of regularly arranged cells. Also, as shown in FIG. 4B, hierarchical data is configured such that different sizes and different levels of detail are set for respective levels. That is, a geographic dataset pertaining to the same region may be stored multiple times such that the dataset has a different size and a different level of detail each time it is stored. Such a data structure is required in order to smoothly visualize geographic data without a load in the geography visualization step. However, much manual work is required in order to generate such 3D geographic data. Specifically, aboveground objects should be manually generated and arranged one by one. Also, depending on the level of detail, it is necessary to generate multiple levels of simplified meshes. Accordingly, it takes a lot of time and expense to generate large-scale geographic data.

When a dataset for 3D geographic data is configured, an apparatus and method for generating 3D geographic data according to an embodiment of the present invention may automatically generate and store a geographic dataset, which enables representation based on a level of detail (LOD) without manual work.

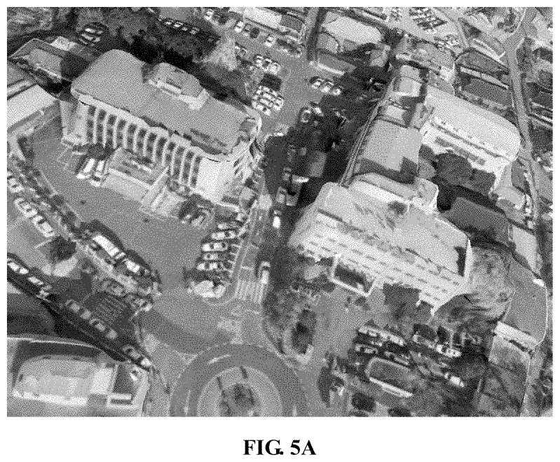

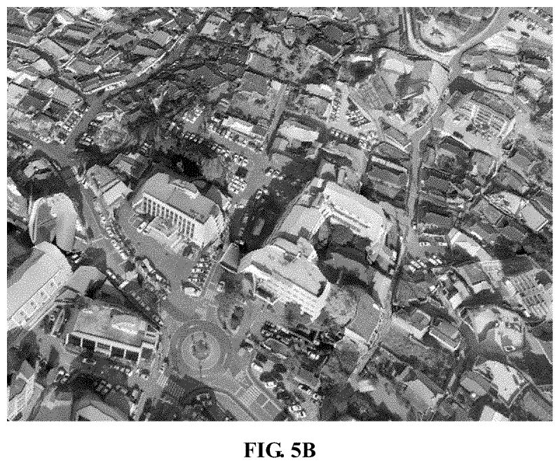

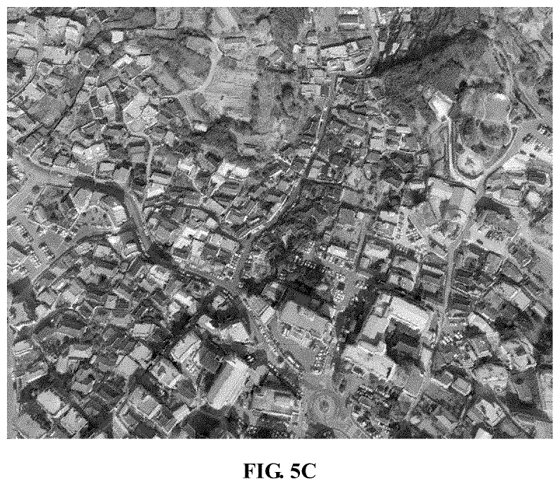

FIGS. 5A, 5B and 5C are exemplary views that show a method for storing geographic data depending on a viewpoint distance according to an embodiment of the present invention. The present invention enables data about terrain and aboveground objects to be generated without manual work and proposes three levels of data storage structures for representing the generated data in 3D based on a visualization viewpoint.

As shown in FIG. 5A, a 3D mesh and texture for automatically reconstructing terrain and aboveground objects, which are to be precisely visualized, may be stored in a short-distance view layer (or a first distance view layer).

In an embodiment, when multi-view images are input, a 3D mesh for terrain or aboveground objects may be automatically generated, but the data size thereof is very large and visualization is time-consuming. Therefore, a 3D mesh and texture may be used when the geography of a small area viewed from a short distance is visualized with high detail.

As shown in FIG. 5B, hybrid Digital Surface Model (DSM) data may be generated and stored in a middle-distance view layer (or a second distance view layer). Here, the hybrid DSM data is data for supporting visualization of geography viewed from a middle distance. For example, the hybrid DSM data may store information about terrain and aboveground objects in the form of a modified height map.

Meanwhile, when a viewpoint distance is equal to or greater than a middle distance, geographic data is no longer smoothly visualized using only a 3D mesh. Accordingly, in order to improve the speed and efficiency of visualization of geographic data, hybrid DSM data in the form of a height map may be stored. For example, the hybrid DSM data may be visualized using specific height-map-rendering technology such as Real-time Optimally Adaptive Meshes (ROAM).

In an embodiment, geographic data may be stored in the form of DSM data, which has the same data type as a height map. In an embodiment, a hybrid ortho-texture map for representing lateral surfaces of aboveground objects may be separately generated and stored along with the hybrid DSM data.

As shown in FIG. 5C, DSM data may be generated in a long-distance view layer (or a third distance view layer). Here, the DSM data may be used when lateral surfaces of aboveground objects are not viewed any longer because a visualization viewpoint is very far. Here, the DSM data and true ortho-texture look almost the same as a conventional DEM and true ortho-texture. However, because the process of excluding aboveground objects is skipped, the DSM data and true ortho-texture, which differ from the conventional DEM and true ortho-texture, may be stored.

As described above, all of the three types of geographic data (a 3D mesh and texture, hybrid DSM data, and DSM data) may be automatically generated from a 3D mesh and texture, which are automatically reconstructed from multi-view images. That is, a hierarchical structure of geographic data may be configured without intervention on the part of human beings.

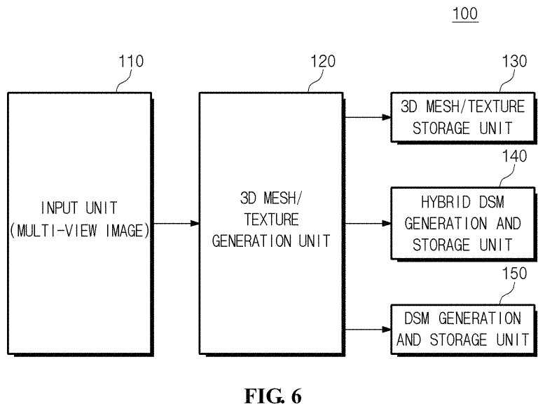

FIG. 6 is an exemplary view that shows an apparatus for generating 3D geographic data according to an embodiment of the present invention. Referring to FIG. 6, the apparatus 100 for generating 3D geographic data may include an input unit 110, a 3D mesh/texture generation unit 120, a 3D mesh/texture storage unit 130, a hybrid DSM generation and storage unit 140, and a DSM generation and storage unit 150.

The input unit 110 may receive image data captured by a drone, an airplane, a satellite, and the like. Here, the input image data may be multi-view image data. Multi-view images for target geography may be provided for automatic 3D reconstruction.

The 3D mesh/texture generation unit 120 calculates 3D information from the input image data, thereby generating a mesh and texture data, which may be visualized in a 3D program.

The 3D mesh/texture storage unit 130 is a storage unit for storing a geography layer for visualization from a short distance. The 3D mesh/texture storage unit 130 may store a mesh and texture, which are generated for each grid cell, in a file format supported by a system. In an embodiment, with an increase in a viewpoint distance, the process of simplifying the mesh and texture is performed, whereby the simplified mesh and texture may be stored in multiple detailed geographic layers included in the short-distance view layer.

The hybrid DSM generation and storage unit 140 reprocesses the mesh and texture in the form of a height map, thereby generating hybrid DSM data and storing the same. For example, the hybrid DSM data may be processed so as to be converted to geographic data in the form of a height map, which includes information about aboveground objects.

Meanwhile, in order to read a large amount of data pertaining to a large area from a storage device and transmit or visualize the same in real time when large-scale geography viewed from a middle distance is visualized, geographic data may be stored in the form of a height map, which may reduce the capacity of geographic data.

In an embodiment, the hybrid DSM generation and storage unit 140 stores geographic data in the form of DSM data, which has the same data type as a height map. Also, the hybrid DSM generation and storage unit 140 may specially generate and store a hybrid ortho-texture map, which may represent information about the lateral surfaces of aboveground objects.

The DSM generation and storage unit 150 reprocesses the mesh and texture in the form of a height map, thereby generating DSM data and storing the same. In an embodiment, the DSM generation and storage unit 150 may store the DSM data and a true ortho-texture.

All of the above-described geographic data types may be automatically generated from a 3D mesh, which is automatically reconstructed from multi-view images. That is, the apparatus 100 for generating 3D geographic data according to an embodiment of the present invention may configure hierarchical geographic data without intervention on the part of human beings.

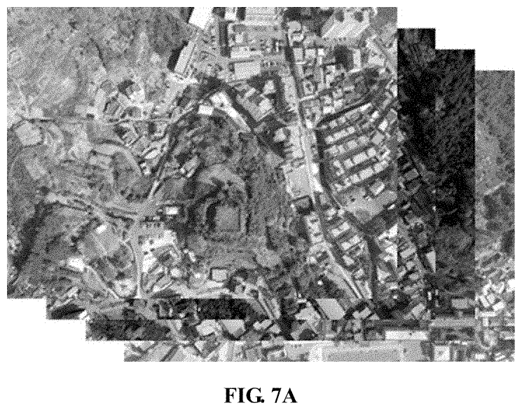

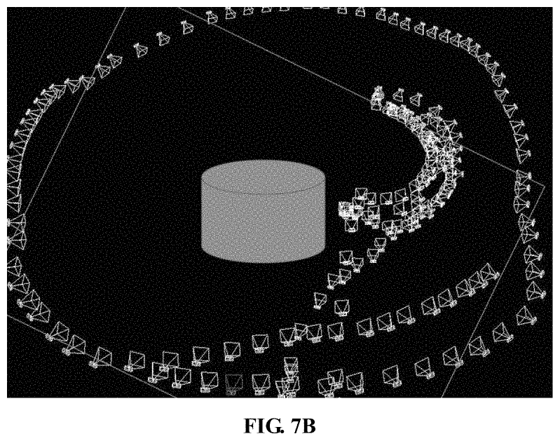

FIG. 7A is an exemplary view that shows multi-view images, and FIG. 7B is an exemplary view that shows the estimated position and orientation of a camera in the multi-view images. In an embodiment, input images and the estimated position and orientation of a camera may be used as important data for automatic reconstruction of a 3D mesh and texture.

Meanwhile, the 3D mesh/texture generation unit 120 may partition data into grid cells and perform operations thereon depending on the geographic data storage system in order to generate data for storage and visualization of large-scale geographic data, rather than 3D data for Computer Graphics (CG)/Virtual Reality (VR).

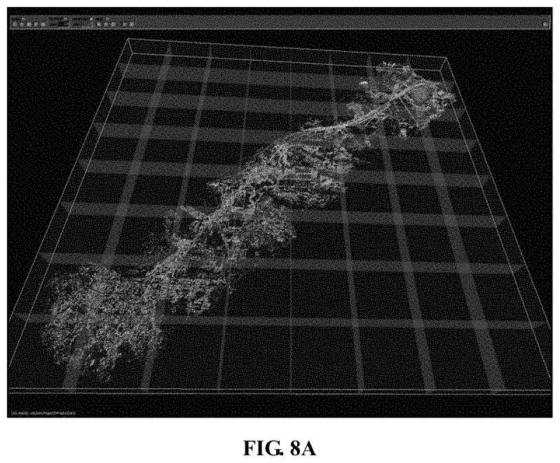

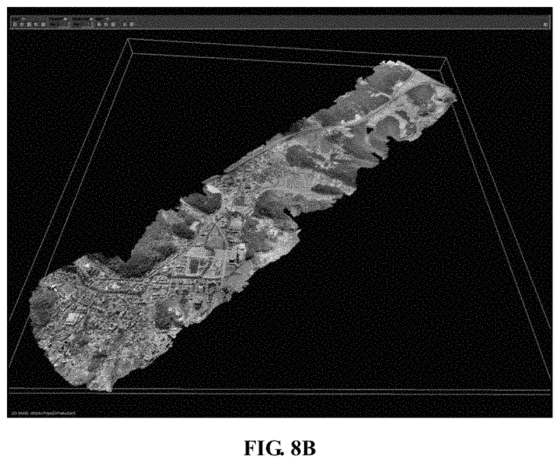

FIG. 8A is an exemplary view that shows a mesh/texture file that is partitioned into 8×8 grid cells, and FIG. 8B is an exemplary view that shows simultaneous visualization of the meshes and texture of 34 valid grid cells after operations are performed on the 8×8 grid cells. Meanwhile, in order to read massive data pertaining to a large area from a storage device and transmit or visualize the same in real time when large-scale geography viewed from a middle distance or farther is visualized, DSM data may be stored in the form of a height map, which may reduce the capacity of geographic data.

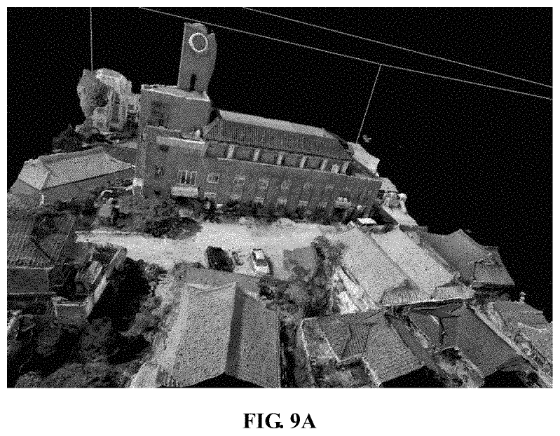

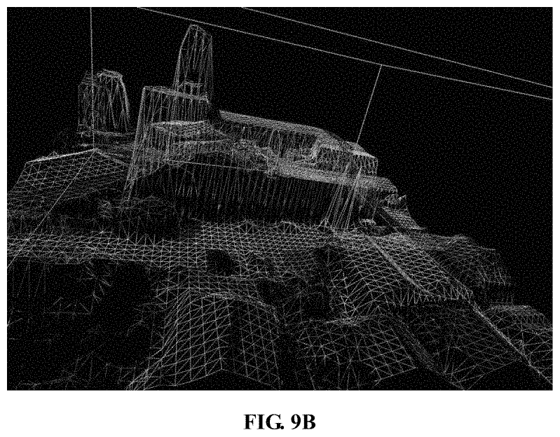

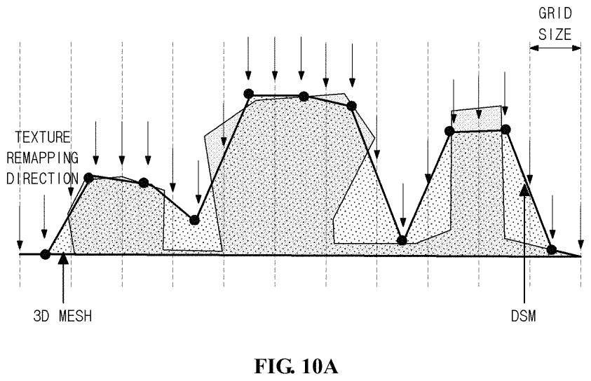

FIGS. 9A and 9B are exemplary views that show the difference between a data capacity when geographic data is stored in the form of a 3D mesh and a data capacity when the geographic data is stored in the form of DSM data, which takes a height map format. When mesh/texture data is stored as shown in FIG. 9A, the capacity of the mesh data is 65 MB and the capacity of the texture data is 26.6 MB. When DSM data is stored as shown in FIG. 9B, the capacity of the DSM data is 17 KB and the capacity of texture data therefor is 2.5 MB.

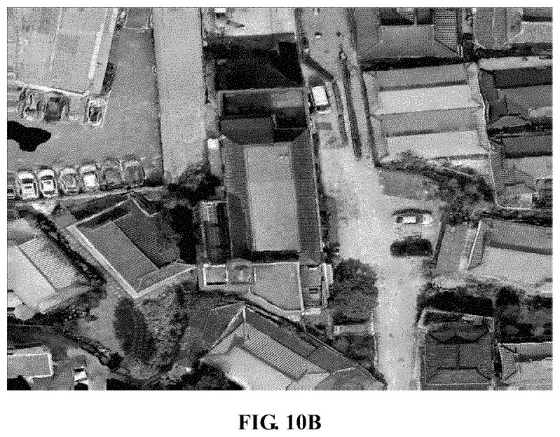

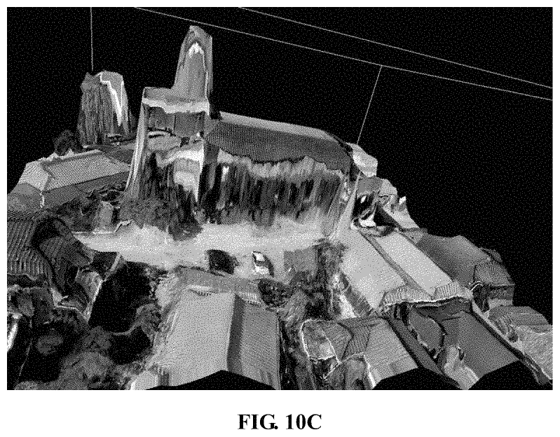

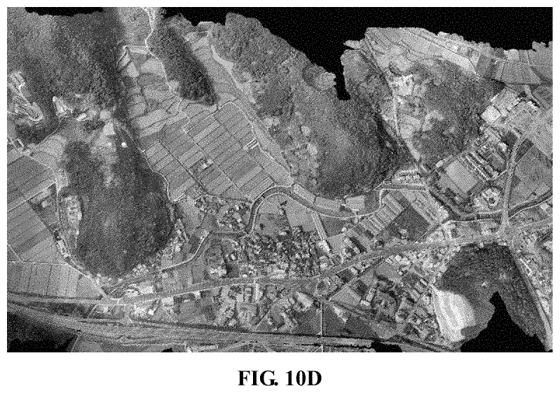

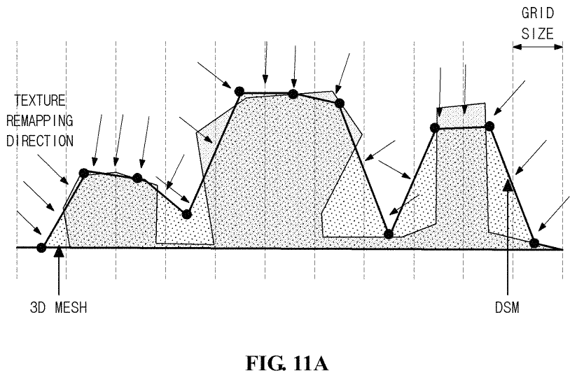

FIG. 10A is an exemplary view that shows the principle based on which 3D mesh data is converted into DSM data and true ortho-texture data, FIG. 10B is an exemplary view that shows true ortho-texture data, FIG. 10C is an exemplary view that shows a combination of DSM data and true ortho-texture data, and FIG. 10D is an exemplary view that shows visualization of geography from a long distance.

When geographic data based on 3D mesh lines is converted into DSM data in the form of a height map and then stored, as shown in FIG. 10A, a difference between two types of geographic data may be created. FIG. 10A shows the process of generating a true ortho-texture by remapping the 3D mesh texture in a vertical direction.

Here, because information about the texture of the lateral surface of a building perpendicular to the ground is not stored as shown in FIG. 10B, information about the lateral surface of the building may be incorrectly represented as shown in the capture image in FIG. 10C. Nevertheless, a dataset comprising DSM data and true ortho-texture may be useful for a long-distance view, from which lateral surfaces of buildings are not viewed, as shown in FIG. 10D.

Meanwhile, the DSM generation and storage unit 150 may generate and store geographic data based on the above-described method. The present invention may add a geography storage layer, to which a new storage method is applied, in order to visualize geography viewed from a middle distance, corresponding to a distance from which a lateral surface of vertical terrain can be observed.

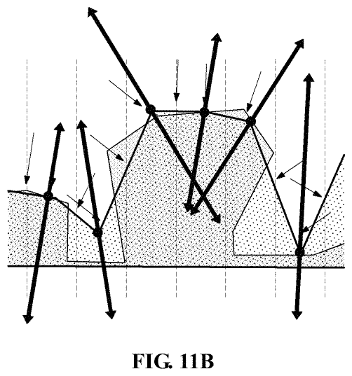

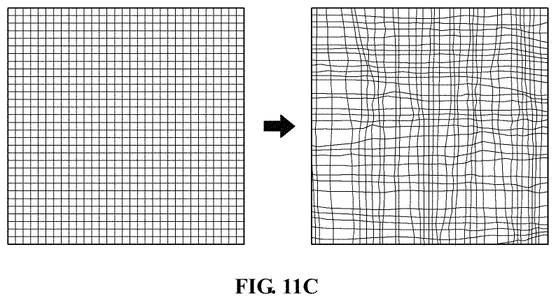

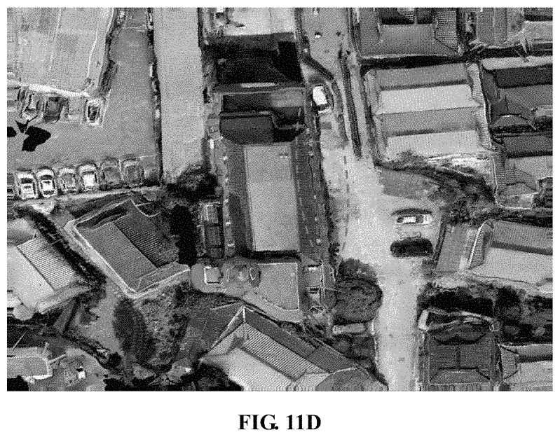

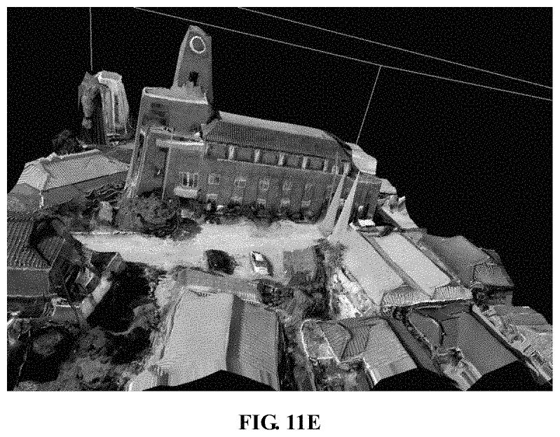

FIGS. 11A, 11B, 11C, 11D and 11E are exemplary views that show hybrid DSM data and hybrid ortho-texture data.

FIG. 11A is an exemplary view that shows the principle based on which a hybrid DSM and hybrid ortho-texture are generated. Referring to FIG. 11A, the direction in which a texture is remapped is not fixed to a vertical direction, unlike in FIG. 10A. As shown in FIG. 11B, the direction in which a texture is remapped may be the same as the orientation of a vector obtained by linearly interpolating each of the vertices in a grid. In FIG. 11B, the bold lines represent the normal vectors of the respective vertices.

Referring to FIG. 11B, a side view is illustrated. Accordingly, clipping planes, each of which includes a mean normal vector to an adjacent grid plane, are represented as lines in the 2D schematization process. In 3D space, each DSM grid cell may have the shape of a quadrangular pyramid or rectangular cylinder by being partitioned by the clipping plane. When all of the texture information in the corresponding space is remapped as the texture of the grid, information about the texture of a lateral surface of a building may be stored, as shown in FIG. 11D. Here, the texture of the lateral surface of the building in the middle of the figure, which is marked with the dotted line, may be stored.

FIG. 11C is a view that shows UV parametrization of hybrid DSM data. In order to secure sufficient space for storing information about the texture of a lateral surface of a building, the DSM data may be newly adjusted to the texture UV space, as shown in FIG. 11C. Generally, UV mapping is a 3D modeling process for wrapping a 2D image onto a 3D model. The simplest UV mapping may include unwrapping a mesh, creating a texture, and applying the texture.

General DSM data is automatically calculated depending on the position on a grid, in which case information about texture UV space is not stored. Accordingly, texture UV coordinates that are regularly spaced are generated when visualization is performed. However, hybrid DSM data according to the present invention enables UV space to be transformed depending on the size of each grid cell in advance in order to secure sufficient space for storing the texture of a lateral surface of a building. Also, irregular UV space may be generated as shown in FIG. 11C, and UV values may be stored along with the elevation values of the DSM. This storage method enables representation of abundant texture information. To this end, hybrid DSM data is stored in the middle-distance view layer of the present invention.

As shown in FIG. 11E, hybrid DSM data and the texture of the lateral surface of a building (hybrid ortho-texture) may be sufficiently represented in the middle-distance view layer.

The apparatus and method for generating 3D geographic data according to an embodiment of the present invention largely classifies large-scale geographic data as any of three layers so as to be stored in different manners depending on the viewpoint distance of a user, thereby configuring a dataset such that visualization is optimized for each viewpoint distance.

The apparatus and method for generating 3D geographic data according to an embodiment of the present invention may be configured to store geographic data in different forms even though the geographic data pertains to the same region. That is, the geographic data may be stored in the form of a fine 3D mesh in order to precisely visualize a small area observed from a short-distance viewpoint (or a first distance viewpoint), may be stored in the form of a hybrid DSM dataset in order to quickly visualize a large area observed from a middle-distance viewpoint (or a second distance viewpoint), and may be stored in the form of a DSM dataset in order to roughly visualize a larger area observed from a long-distance viewpoint (or a third distance viewpoint), whereby the same region may appear differently in the visualization step.

The apparatus and method for generating 3D geographic data according to an embodiment of the present invention generates a hybrid DSM dataset for visualization of geography observed from a middle-distance viewpoint, from which it is possible to view the lateral surface of terrain or a building, stores the hybrid DSM dataset along with texture UV values, which are readjusted so as to store the texture of a lateral surface, and interpolates the direction in which the DSM texture is remapped from a 3D mesh depending on the direction of a clipping plane of each grid cell, thereby overcoming a disadvantage in which existing DSM/DEM texture represents only the texture in a vertical direction.

The apparatus and method for generating 3D geographic data according to an embodiment of the present invention may enable information about lateral surfaces observed from a middle-distance viewpoint to be represented and quickly visualize a large area in real time.

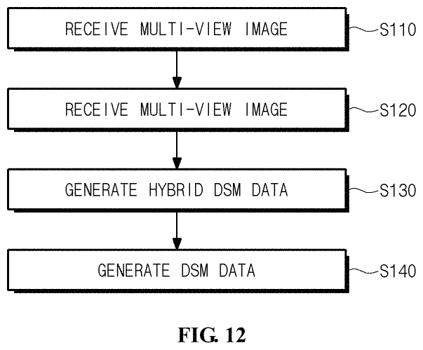

FIG. 12 is an exemplary view that shows an operating method of an apparatus for generating 3D geographic data according to an embodiment of the present invention. Referring to FIGS. 5 to 12, the apparatus 100 for generating 3D geographic data may operate as follows.

Multi-view images may be input from a drone, an airplane, a satellite, and the like at step S110. 3D information is calculated from the input multi-view images, whereby a 3D mesh and texture may be generated at step S120. Here, the 3D mesh and texture may be used for visualization of geography viewed from a short distance.

Hybrid DSM data may be generated at step S130 by reprocessing the 3D mesh and texture in the form of a height map. Here, the hybrid DSM data may be used for visualization of geography viewed from a middle distance. In an embodiment, a hybrid ortho-texture map for providing information about lateral surfaces of aboveground objects may be generated along with the hybrid DSM data.

DSM data may be generated at step S140 by reprocessing the 3D mesh and texture in the form of a height map. Here, the DSM data may be used for visualization of geography viewed from a long distance. In an embodiment, DSM data and a true ortho-texture may be generated.

In an embodiment, with an increase in a viewpoint distance, the process of simplifying a mesh/texture is performed. The simplified mesh/texture may be classified and stored for each detailed geographic layer in the first distance view layer.

In an embodiment, the direction in which the DSM texture is remapped from the 3D mesh may be interpolated depending on the direction of the clipping plane of each grid cell.

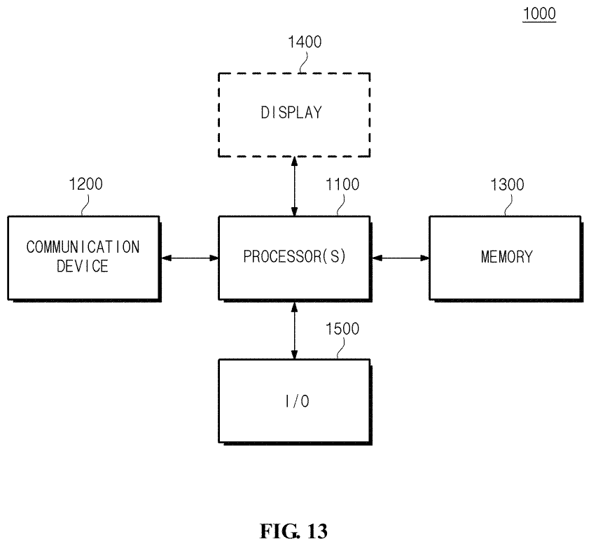

FIG. 13 is an exemplary view that shows an apparatus 1000 for generating 3D geographic data according to an embodiment of the present invention. Referring to FIG. 13, the apparatus 1000 for generating 3D geographic data may include at least one processor 1100, a network interface 1200, memory 1300, a display 1400 and an input/output device 1500.

The processor 1100 may include at least one of the devices described with reference to FIGS. 5 to 11, or may be implemented using at least one of the methods described with reference to FIGS. 5 to 11. The processor 1100 may execute instructions in order to receive multi-view images, to generate a 3D mesh and texture for a first distance view from the multi-view images, to generate a hybrid DSM dataset for a second distance view using the 3D mesh and texture, and to generate a DSM dataset for a third distance view using the 3D mesh and texture, as described above.

The processor 1100 may run programs and control the apparatus 1000 for generating 3D geographic data. The apparatus 1000 for generating 3D geographic data may be connected with an external device (e.g., a personal computer or a network) and may exchange data therewith via the I/O devices 1500. The apparatus 1000 for generating 3D geographic data may be any of various types of electronic systems, including mobile devices such as a mobile phone, a smartphone, a PDA, a tablet PC, a laptop, and the like, computing devices such as a PC, a tablet PC, a netbook, and the like, and electronic devices such as a TV, a smart TV, a security device for gate control, and the like.

The network interface 1200 may be implemented so as to communicate with an external network using any of various wired/wireless methods.

The memory 1300 may store computer-readable instructions. The processor 1100 may perform the above-described operations by executing the instructions stored in the memory 1300. The memory 1300 may be volatile or nonvolatile memory. The memory 1300 may include a storage device in order to store user data. The storage device may be an embedded multimedia card (eMMC), a solid-state drive (SSD), universal flash storage (UFS), or the like. The storage device may include at least one nonvolatile memory device. The nonvolatile memory device may be any one of NAND flash memory, Vertical NAND (VNAND), NOR flash memory, Resistive Random-Access Memory (RRAM), Phase-Change Memory (PRAM), Magnetoresistive Random-Access Memory (MRAM), Ferroelectric Random-Access Memory (FRAM), Spin-Transfer-Torque Random-Access Memory (STT-RAM), and the like.

The embodiments described above may be implemented through hardware components, software components, and/or a combination thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, and any other device capable of executing instructions and responding thereto. The processing device may run an operating system (OS) and one or more software applications executed on the OS.

Also, the processing device may access, store, manipulate, process, and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner The software and data may be stored in one or more computer-readable storage media.

The method according to the embodiments may be implemented as program instructions executable by various computer devices, and may be recorded in computer-readable storage media. The computer-readable storage media may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured such that it operates as one or more software modules in order to perform the operations of the embodiment, and vice-versa.

The present invention may generate large-scale geographic data using three different methods such that the geographic data is hierarchically stored depending on a visualization viewpoint distance. Particularly, a hybrid DSM for a middle-distance view may efficiently represent information about the texture of lateral surfaces of buildings or terrain by overcoming the disadvantage of an ortho-texture map of existing DEM/DSM.

The apparatus and method for generating 3D geographic data according to an embodiment of the present invention are configured to classify large-scale geographic data as any of three layers so as to be stored in different manners depending on the viewpoint distance of a user. Accordingly, a dataset may be configured such that visualization is optimized for each viewpoint.

The apparatus and method for generating 3D geographic data according to an embodiment of the present invention may be configured such that geographic data may be stored in different manners even though the geographic data pertains to the same region. Specifically, the geographic data may be stored as a dataset in the form of a fine 3D mesh in order to precisely visualize a small area observed from a short-distance viewpoint (or a first distance viewpoint), may be stored as a hybrid DSM dataset in order to quickly visualize a large area observed from a middle-distance viewpoint (or a second distance viewpoint), and may be stored as a DSM dataset in order to roughly visualize a large area observed from a long-distance viewpoint (or a third distance viewpoint), whereby even the same region may appear differently in the visualization step.

The apparatus and method for generating 3D geographic data according to an embodiment of the present invention are configured to generate a hybrid DSM dataset for visualization of geography observed from a middle-distance viewpoint, which corresponds to a distance from which it is possible to view a lateral surface of terrain or a building, to store the hybrid DSM along with texture UV values, which are readjusted so as to store the texture of a lateral surface, and to interpolate the direction in which a DSM texture is remapped from a 3D mesh depending on the direction of a clipping plane of each grid cell, thereby overcoming a disadvantage in which existing DSM/DEM texture technology represents only texture in a vertical direction.

The apparatus and method for generating 3D geographic data according to an embodiment of the present invention may represent information about lateral surfaces observed from a middle-distance viewpoint so as to enable quick visualization of a large area in real time.

Meanwhile, the above description is merely specific embodiments for practicing the present invention. The present invention encompasses not only concrete and available means but also the technical spirit corresponding to abstract and conceptual ideas that may be used as future technology.

What is claimed is:

1. An operating method of an apparatus for generating 3D geographic data, comprising:
receiving multi-view images;
generating a 3D mesh and texture for a first distance view from the multi-view images;
generating hybrid Digital Surface Model (DSM) data for a second distance view using the 3D mesh and the texture; and
generating DSM data for a third distance view using the 3D mesh and the texture.

2. The operating method of claim 1, wherein generating the 3D mesh and the texture comprises:
calculating 3D information from the multi-view images, thereby generating the 3D mesh and texture that are capable of being visualized in a 3D program.

3. The operating method of claim 2, further comprising:
storing the 3D mesh and the texture for the first distance view in a first distance view layer.

4. The operating method of claim 3, wherein storing the 3D mesh and the texture comprises:
simplifying the 3D mesh and the texture with an increase in a viewpoint distance;
classifying the simplified 3D mesh and the simplified texture for each detailed geographic layer; and
storing the simplified 3D mesh and the simplified texture for each detailed geographic layer in the first distance view layer.

5. The operating method of claim 1, wherein generating the hybrid DSM data comprises:
reprocessing the 3D mesh and the texture in a form of a height map, thereby generating the hybrid DSM data.

6. The operating method of claim 5, further comprising:
storing the hybrid DSM data in a second distance view layer.

7. The operating method of claim 5, wherein generating the hybrid DSM data further comprises:
generating a hybrid ortho-texture map for displaying information about lateral surfaces of aboveground objects.

8. The operating method of claim 7, wherein generating the hybrid DSM data further comprises:
interpolating a direction in which a DSM texture is remapped from a 3D mesh depending on a direction of a clipping plane of each grid cell.

9. The operating method of claim 1, further comprising:
storing the DSM data in a third distance view layer.

10. The operating method of claim 9, wherein storing the DSM data comprises:
storing a true ortho-texture along with the DSM data.

11. An apparatus for generating 3D geographic data, comprising:
at least one processor; and
memory for storing at least one instruction executed by the at least one processor,
wherein the at least one instruction is executed by the at least one processor so as to receive multi-view images, to generate a 3D mesh and texture for a first distance view from the multi-view images, to generate a hybrid Digital Surface Model (DSM) dataset for a second distance view using the 3D mesh and the texture, and to generate a DSM dataset for a third distance view using the 3D mesh and the texture.

12. The apparatus of claim 11, wherein the hybrid DSM dataset includes hybrid DSM data in a form of a height map and texture UV values having information about lateral surfaces of aboveground objects.

13. The apparatus of claim 11, wherein a DSM texture is remapped from the 3D mesh by performing interpolation depending on a direction of a clipping plane of each grid cell.

14. The apparatus of claim 11, wherein the hybrid DSM dataset includes hybrid DSM data in a form of a height map and a hybrid ortho-texture having information about lateral surfaces of aboveground objects.
